(19) United States
(12) Patent Application Publication
(10) Pub. No.: US 2005/0005876 A1
(43) Pub. Date: Jan. 13, 2005

(54) Leash for animals, applicable to a vehicle

(76) Inventor: Cesare Calvi, Parma (IT)

Correspondence Address: CASTELLANO MALM FERRARIO & BUCK LLC, 2121 K STREET, NW, SUITE 800, WASHINGTON, DC, 20037, US

(21) Appl. No.: 10/501,006

(22) PCT Filed: Apr. 11, 2003
(86) PCT No.: PCT/IT03/00229

(30) Foreign Application Priority Data
Mar. 19, 2003 (IT) PR2003A000019

(51) Int. Cl. B60R 22/10

(52) U.S. Cl. 119/771

(57) ABSTRACT

A leash for animals applicable to a vehicle comprises a bar (5), means for fastening the bar to the frame of the vehicle, a rope (2) associated to the bar and provided with means for fastening to the collar of the animal, and it is characterised in that the bar (5) is internally hollow and houses one or more springs (4) operating in compression when the animal stresses the rope (2). The means for fastening the bar to the frame of the vehicle comprise:

First fastening means (6, 7, 8, 9, 10, 13) anchored to the frame of the vehicle; second fastening means (11) associated to the bar and so shaped as to be fastened and/or released rapidly by simple coupling/uncoupling to the first fastening means.

The present invention relates to a leash for animals able to be applied to a vehicle, and in particular it refers to the case of a dog leash able to be applied to a vehicle with two or three wheels, with or without engine propulsion, such as bicycles, tricycles, mopeds, sleds.

U.S. Pat. No. 4,854,269 teaches a retention device that is fastened to the frame of a bicycle to keep a dog at the leash, while keeping both hands on the handlebar. The device comprises a bracket that is fastened to an upright of the frame, a first bar that extends laterally to the bicycle and is secured to the bracket, a second bar elastically connected to the first by means of a helical spring working in traction, a cable connected to the end of the second bar opposite to the spring, a pair of notched rings which, by opening, release the dog from the retention device, if the dog stresses the bicycle frame with excessive force.

U.S. Pat. No. 4,134,364 discloses a device constituted by a single bar fastened to the bicycle frame. The bar is provided with a flexible pivot pin whereto is anchored a small chain in such a way that said pivot pin constitutes an automatic release means in case of excessive stress exerted by the dog.

CA 2151542 teaches a device constituted by a bar connected to a bicycle frame by means of a rotating joint, in correspondence with the axle of the rear wheel. The joint allows the bar to oscillate in the vertical and horizontal direction according to the dog's movements. The bar has in its interior a helical spring that operates in traction and is connected to a rope that terminates with a spring catch for connecting a collar.

DK 9600464 discloses a device constituted by a bar fastened to the frame of a bicycle and provided with a spring that works in traction and is connected to a small chain.

All the aforementioned documents illustrate devices wherein the bar or bars fastened to the bicycle frame can be removed with difficulty therefrom, by unscrewing the anchoring bracket or unscrewing the bar, or removing the locking means with difficulty.

An additional drawback of the prior art is that it provides for the use of a single spring operating in traction, which is thus prone to weakening.

A further drawback is the impossibility of adequately adjusting the height of the device to the height of the dog, also taking into account its mass.

Another drawback is given by the fact that, when the dog's owner stops, gets off the bicycle and wishes to walk with his/her dog, (s)he needs to have a leash to attach to the dog collar.

An aim of the present invention is to eliminate the aforesaid drawbacks and to make available a leash which can be applied to a bicycle in easily removable fashion.

An additional aim is to make said leash suitable to dogs or animals of different sizes, within the scope of a simple and economical solution.

Said aims are fully achieved by the leash of the present invention, which is characterised by the contents of the claims set out below and in particular in that it comprises a bar, anchored to the vehicle and internally hollow, which houses one or more springs operating in compression when the animal stresses a rope connected to the bar.

The means for securing the bar to the frame of the vehicle preferably comprise a pair of semi-cylindrical jaws that encompass the frame and are fastened thereto by means of bolts or lever systems (for instance those already in use in bicycles), in which one of the two jaws has a protuberance so shaped as to be anchored in a corresponding cavity of a rapid snap-on coupling of the female type, screwed to an end of the bar.

The bar, in correspondence with the vehicle-side end can be provided with a grip or handle for use as a normal leash once the bar is detached from the vehicle.

This and other characteristics shall become more readily apparent from the description that follows of a preferred embodiment shown, purely by way of non limiting example, in the accompanying drawing tables in which:

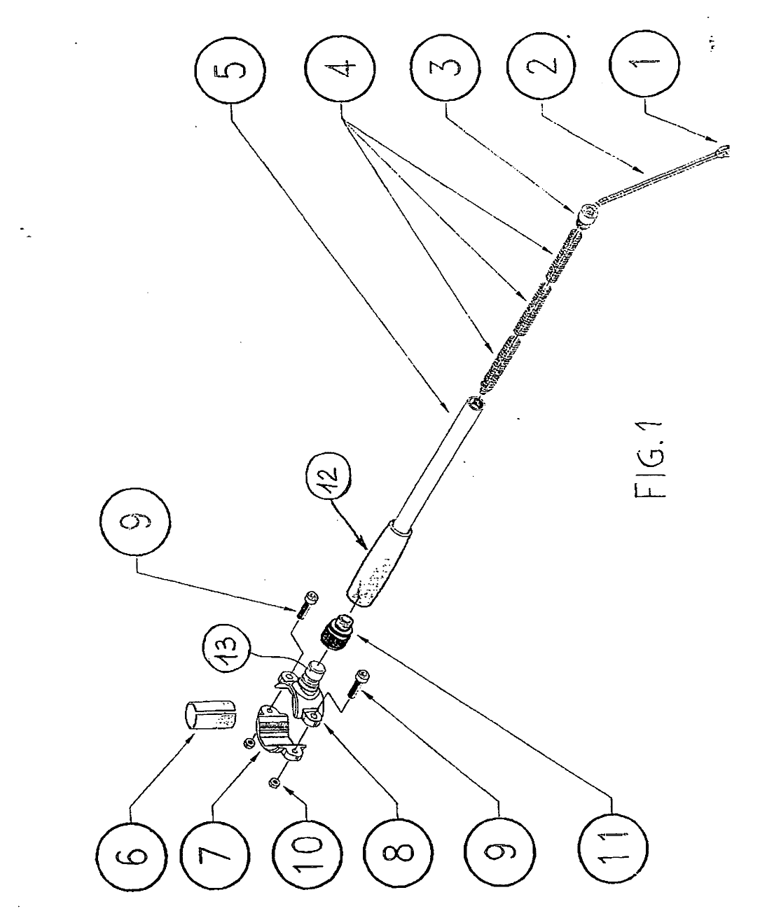

FIG. 1 shows an exploded view of the leash and the means to associate it to a vehicle and to a collar of an animal;

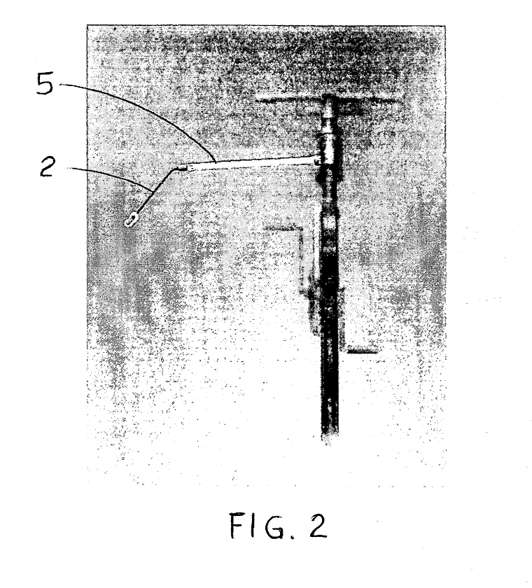

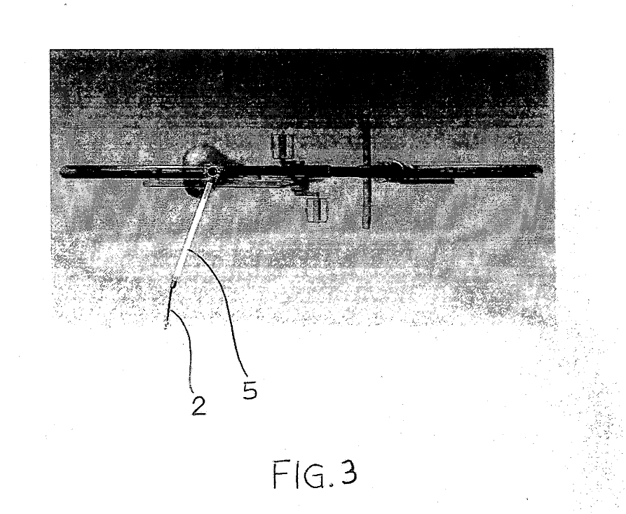

FIGS. 2 and 3 schematically show the application of the leash on a vehicle, in this specific case a bicycle.

With reference to the figures, the number 1 designates a hook, of the type commonly called “spring catch”, able to be anchored to the collar, not shown herein, of an animal, typically a dog.

The spring catch 1 constitutes means for latching onto the collar of an animal.

A string 2 or rope, which may be elastic, is inserted in an eyelet of the hook and then traverses, substantially in bifilar form, a closure ogive or cap 3 and three springs 4 to be closed in a terminal knot downstream of said three springs, which are housed inside a hollow bar 5.

The bar 5 is coated with a grip or handle 12 in correspondence with an end in which a female snap-on rapid coupling 11 is screwed, destined to interact with a corresponding protuberance 13 exhibited by a front jaw 8.

The front jaw 8 and a rear jaw 7, substantially with semi-cylindrical shape, encompass, preferably with the interposition of a sheath 6, around the frame of a bicycle (FIGS. 2 and 3) or of another vehicle such as a tricycle or a moped, typically in the area underlying the seat, and are fastened to the frame itself by means of bolts constituted by screws 9 and nuts 10, or are fastened to the frame by means of lever systems of the type already commonly used in bicycles.

The jaws with the sheath and the bolts are first securing means permanently fastened to the frame of the vehicle, although it is possible to disassemble them acting on the bolts. Said first securing means interact with second securing means associated with the bar and constituted by the quick coupling fitting 11, in order globally to constitute means for securing the bar to the frame in easily removable fashion.

The type of securing is particularly rapid and effective and uses a hollow quick coupling fitting 11 and a protuberance 13 which are substantially similar to the couplings used in the field of garden and lawn irrigation to connect the spraying hoses to taps or to other tools.

The grip 12 serves as a handle for the operator to use the bar as a normal leash once it is detached from the vehicle.

The bar contains within it three springs 4, but there could also be one spring or in any case a number other than three, which can easily be replaced simply by unscrewing the ogive 3 and untying the terminal knot of the rope. The replacement of the springs can serve to adapt the leash to dogs or animals of different size, hence destined to the stress the vehicle with more or less intense force.

The end of the spring closest to the frame of the vehicle is tapered, i.e. it has a conicity, clearly shown in the figure, to allow a simple terminal knot to prevent the rope from returning in the spring. Essentially, the exit hole of said spring will be only slightly larger than the diameter of the spring or of the springs that traverse it.

The fact that the rope passes through the eyelet of the hook 1 and returns in bifilar form through the springs enables a single node to be able to fasten the rope, but according to a different embodiment, not shown herein, the springs may be traversed by a single cable, knotted at the exit from the springs and also knotted to the eyelet of the hook.

Unlike the prior art, the present invention allows a rapid fastening and unfastening by coupling/uncoupling the bar to the frame of the bicycle and it also allows to use the bar, once it is detached from the frame, as a normal leash without the user's having to bring with him/her an additional leash when (s)he wishes to walk with his/her dog.

The fact that the springs work in compression assures their duration, and it provides a physical limit to the possible travel of the spring 2 as a consequence of the stresses imparted by the dog, both when the leash is held by the user's hand and when the leash is anchored to the vehicle.

The present invention also allows to use the same bar on different bicycle (for instance owned by the same family), previously provided with the fastening jaw alone and for this reason the bar with the rope may be sold separately from the means for fastening to the vehicle.

As shown in FIGS. 2 and 3, the leash is positioned projecting laterally from the vehicle, in the specific case a bicycle, and the bar takes on a configuration that is substantially horizontal or inclined downwards by 0°-30°, (FIG. 2) and substantially orthogonal to the longitudinal axis of the vehicle or slightly inclined backwards (FIG. 3) by about 0°-35°.

1. Leash for animals applicable to a vehicle having a frame comprising
a bar,
means for fastening the bar to the frame of the vehicle,
a rope associated to the bar, and
means for fastening the rope to the collar of the animal,
wherein the bar is internally hollow and houses one or more springs (4).

2. The leash as claimed in claim 1, wherein the means for fastening the bar to the frame of the vehicle comprises:
first fastening means, capable of anchoring to the frame of the vehicle;
second fastening means associated to the bar and so shaped as to be fastened and/or released by coupling/uncoupling to the first fastening means.

3. The leash as claimed in claim 2, wherein the first fastening means comprises:
a pair of semi-cylindrical jaws which encompass a frame and are fastened thereto by means of bolts,
wherein one of the two jaws has a protuberance so shaped as to be anchored in a corresponding hollow of the second fastening means.

4. The leash as claimed in claim 2, wherein the second fastening means comprises:
a female snap-on rapid coupling, screwed on an end of the bar,
wherein the female snap-on rapid coupling is capable of being coupled with a protuberance exhibited by the first fastening means.

5. The leash as claimed in claim 1, wherein the bar further comprises a handle on an end of the bar proximate to the means for fastening the bar to the frame of the vehicle.

6. The leash as claimed in claim 1, wherein the one or more springs comprise at least two springs in series.

7. The leash as claimed in claim 1, wherein the rope passes through an eyelet comprised in the means for fastening the rope to the collar of the animal, wherein the rope traverses at least one spring (4) contained in the bar, and wherein the rope is knotted at an end of the spring that is closest to the frame of the vehicle.

8. (deleted).

9. The leash as claimed in claim 1, wherein the leash is arranged projecting laterally from the vehicle and the bar assumes between a substantially horizontal configuration and a configuration that is inclined downwards by between about 0-30 degrees, and substantially orthogonal to the longitudinal axis of the vehicle or slightly inclined backwards by between about 0-35 degrees.

10. (deleted).

11. The leash as claimed in claim 1, wherein the vehicle is selected from the group consisting of a bicycle, a tricyle or a moped.

12. The leash as claimed in claim 1, wherein the one or more springs are capable of compressing when an animal stresses the rope.

13. The leash as claimed in claim 1, wherein the one or more springs comprise at least three springs in series.

14. The leash as claimed in claim 1, further comprising a closure cap arranged of the bar for retaining the one or more springs in the bar, and which is removable to permit the removal of the one or more springs.

15. A vehicle, comprising the leash of claim 1.

16. The vehicle as claimed in claim 15, wherein the vehicle is selected from the group consisting of a bicycle, a tricyle or a moped.
